(19) United States
(12) Patent Application Publication
(10) Pub. No.: US 2002/0078042 A1
(43) Pub. Date: Jun. 20, 2002

(54) System and method for determining affinity relationships

(75) Inventor: Vicente Carlos Gutierrez Mata, Saltillo (MX)

Correspondence Address: Mark V. Muller, Jenkens & Gilchrist, P.C., 3200 Fountain Place, 1445 Ross Avenue, Dallas, TX, 75202-2799, US

(73) Assignee: TELEFONAKTIEBOLAGET L M ERICSSON (pub1)

(21) Appl. No.: 09/740,609

(22) Filed: Dec. 19, 2000

(51) Int. Cl. G06F 17/30

(52) U.S. Cl. 707/5; 707/10; 705/1; 707/104.1

(57) ABSTRACT

Affinity relationships are determined and communications are established between a first party user and second party user through a memory, a selection module, and a contact module. The memory includes a database with records corresponding to various users, such that each record is personalized according to characteristic information corresponding to the users. The selection module compares the characteristic information to determine a degree of affinity, and the contact module establishes a call connection between parties having a degree of affinity greater than some preselected amount.

A first selected record including characteristic information corresponding to a first user is read and a second selected record including characteristic information corresponding to a second user is read. The degree of affinity between the users is determined by comparing the characteristic information. A call connection between the users is established when the degree of affinity is greater than the preselected amount.

### BACKGROUND OF THE INVENTION

1. Technical Field

This invention relates generally to communications between parties, and more particularly, to determining affinity relationships, or shared properties and personal preferences between persons, and then enabling communications between them.

2. History of Related Art

With advances in telecommunications technology, it has become easier than ever to initiate communications between parties. In an effort to differentiate themselves, telecommunications service providers constantly search for opportunities to create new services. Call-forwarding, caller-identification, and call-waiting are examples of services which have arisen, and become even more important, due to the use of cellular telephones. That is, a mobile society with the ability to communicate in motion, creates new opportunities for the provision of services.

Another aspect of the increase in technology and communication is the concomitant decrease in personal interaction between people. It is now easier than ever to simply pick up a telephone, or use a computer to contact business associates and even close friends. Thus, many people are searching for ways to encounter others on a more personal level, for non-business reasons. Evidence of this phenomenon can be seen in the rise of “personal” advertisements and dating services.

An attempt to guide people with similar interests toward personal interaction exists in a very rudimentary form. Key rings, including some form of encoded identification, have been manufactured for distribution to the public. These key rings operate to make an audible sound whenever two units come into close proximity with one another, and the units share some form of coding, for example, preference for a particular product or brand. However, the interactive range of the key rings is quite limited. The amount of shared information is also limited and directed toward the marketing interest of the key ring vendor, rather than the interests of the persons carrying the key rings.

Therefore, what is needed is a method and apparatus for determining affinity relationships between persons which operate at selected, or even at indeterminate distances. Such a method and apparatus should allow users to personalize the information used for affinity comparisons, and further, to designate any of several modes in which the system might operate. For example, such a system would be particularly useful if users were allowed to participate on an active, or passive basis. Such a system would also be most useful if users were able to alter the degree of affinity required for establishing communication between parties.

### SUMMARY OF THE INVENTION

The invention provides a mechanism for determining affinity relationships and enabling communications between parties with similar interests. A database is stored in a memory, containing records corresponding to characteristic information for a plurality of users. The characteristic information may be entered by the user, or service provider, as directed by the user, according to standard templates, or in some type of free-form format. The invention includes a selection module for comparing characteristic information in a record corresponding to a first party with characteristic information in a record corresponding to a second party, wherein both records typically reside within the same database. The invention also includes a selection module for comparing the characteristic information in the selected records to determine a degree of affinity, and a contact module for enabling a call connection between parties for which a degree of affinity is found to exist. Typically, the call connection is only enabled if the existing degree of affinity is greater than some preselected amount of affinity determined by the parties.

The system of the invention may be located within a telecommunications node, such as a Mobile Switching Center (MSC), or a Home Location Register (HLR). The records within the database may be divided into groups or series, such as various categories of interest, including animal lovers, music lovers, movie lovers, etc. The degree of affinity is usually determined according to the number of items in the records which are substantially equivalent, and may be increased according to the proximity of the users.

The invention may be embodied by an active system, or a passive system. The active system operates as described above, namely, the system itself operates to constantly search one or more databases in an effort to identify affinity relationships. An alternative method of operation, i.e., the passive system, may include assigning a status to users, such as “looking” or “idle”. Thus, users may select their own status and, depending on the status, whether the system will include them in search efforts. Essentially, a user with the status of “looking” desires active participation in the system, and may even offer to pay for the cost of an inter-party telephone call. An “idle” user may also desire to participate, but does not want to pay for the cost of an inter-party call. A third status may be “busy” which designates a user that does not desire to be contacted by the system when an affinity relationship is found. Thus, the system may refrain from contacting the user, or simply leave the “busy” user out of the search process entirely.

The invention also includes a method for determining affinity relationships and enabling communications between parties. The method includes the steps of reading selected records for a first party user, and a second party user. The records each include characteristic information corresponding to the first and second parties. The method includes the step of determining a degree of affinity by comparing the characteristic information in the records, and enabling a call connection between the first party and second party users when the degree of affinity is about greater than or equal to a preselected amount of affinity. The degree of affinity may be determined as noted above. Characteristic information may include the age, sex, music type, telephone number, etc. of the users. The method may also include enabling a call connection between the users based upon the degree of affinity, and the user status designation, as noted above.

### BRIEF DESCRIPTION OF THE DRAWINGS

A more complete understanding of the structure and operation of the present invention may be had by reference to the following detailed description when taken in conjunction with the accompanying drawings, wherein:

FIG. 1 illustrates an exemplary database included in the system of the present invention;

FIG. 2 illustrates an embodiment of the passive system of the present invention;

FIG. 3 illustrates an embodiment of the active system of the present invention; and

FIG. 4 illustrate the method of the present invention as it operates in the active and passive modes.

### DETAILED DESCRIPTION OF PRESENTLY PREFERRED EXEMPLARY EMBODIMENTS

The invention provides a new system and apparatus to determine affinity relationships between parties and enable communication between them. Thus, a first party having certain preferences and identifying characteristics may be added to communicate with a second party having similar preferences and/or identifying characteristics according to the degree of affinity determined by the system and method of the present invention. A call connection may then be enabled between the parties whose degree of affinity is about greater than or equal to a preselected amount of affinity, as determined by the parties themselves, or the system and method.

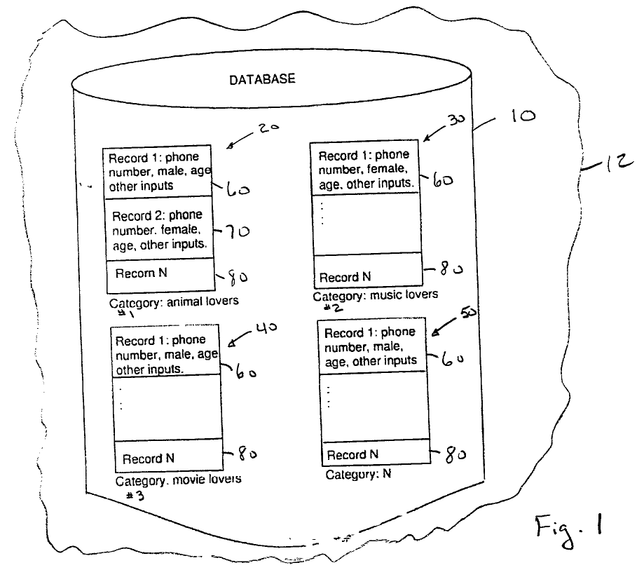

Turning now to FIG. 1, an exemplary database 10 can be seen. Typically, the database 10 resides within a memory 12, and includes a plurality of records 60, 70, and 80. However, the database 10, may also exist in multiple parts, in different physical locations (e.g. half of the database 10 records in one network node, and the other half in another node). The records may be divided into groups, categories, or series, such as a first records series 20 (e.g., animal lovers), a second series of records 30 (e.g., music lovers), a third series 40 (e.g., movie lovers), and an N^{th} series 50. In other words, the plurality of records can be divided into one or more series of records, each of the records within a category/series/group according to some common characteristic or preference of the users so categorized. Some records may even be placed in multiple series, if desired.

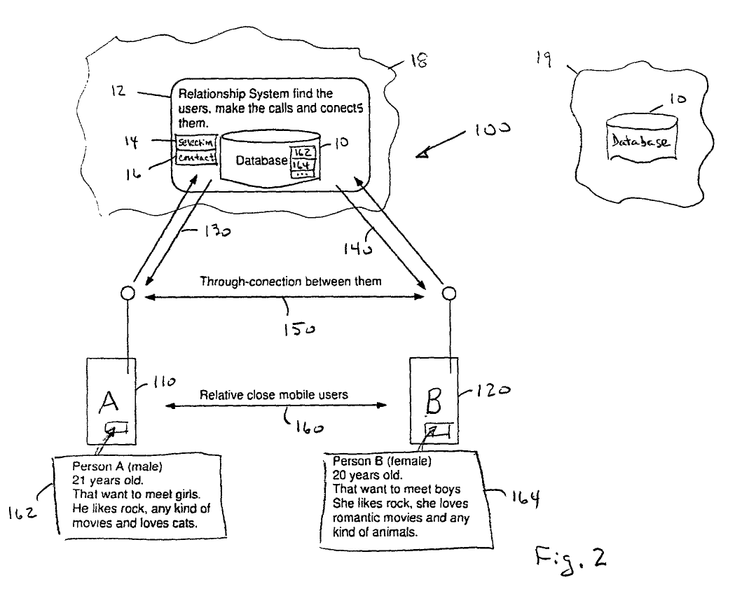

Turning now to FIG. 2, the active system 100 of the present invention can be seen. Here the database 10 contains user records 162, 164 in a memory 12. For example, the first records 162 may include characteristic information corresponding to a first party user A operating a mobile cellular telephone 110, and the second records 164 may include characteristic information associated with a second party user B operating a mobile cellular telephone 120. Of course, the telephones 110, 120 may be replaced by pagers, fixed/desktop telephones, or other communications devices, such as radios. In each case, the first party user A and second party user B are separated by a user proximity distance 160. As shown in FIG. 2, information that forms the user records 162, 164 or even the user records 162, 164 themselves may be stored in the telephones 110, 120, respectively, for uploading to the database 10, which may be divided between, for example, node 18 and node 19. Uploading of the information and/or records 162, 164 to the database 10 may occur by way of the first user data connection 130, and the second user data connection 140, respectively. The data connections 130, 140 may be wireless, or wireline.

The memory 12 typically resides in a node 18, which may be a MSC, HLR, an Internet server, or some other device capable of executing programs from memory.

The records 162, 164 include a selection of characteristic information which may be used to determine an affinity relationship between the first and second party users A and B. For example, the first party user A is associated with record 162 including characteristic information indicating that the first party user A is male, twenty-one years old, and would like to meet girls. He likes rock music, any kind of movies, and cats. As a matter of contrast, second party user B is associated with record 164, including characteristic information including that the second party user B is female, twenty years old, and would like to meet boys. She likes rock music, romantic movies, and any kind of animals.

A selection module 14 typically residing in the memory 12 in the form of a software program module, is used to compare the characteristic information of the parties A, B. The degree of affinity between the first and second party users A, B is determined by comparing the characteristic information in the records 162, 164. In this particular case, the users A, B are both about the same age, would like to meet someone of the opposite sex, and both parties like rock music. The parties A, B interests in movies and animals also match, since each likes a particular subcategory of the general category preferred by the other. Thus, one would expect a high degree of affinity between the parties A, B. Therefore, the degree of affinity typically increases according to the amount of characteristic information in the records which is identical, or substantially equivalent. Thus, absolute degree of affinity can be determined by some degree of equivalence between each of the items of characteristic information, or by identity of information between the various pieces of characteristic information. Further, the absolute degree of affinity may be determined by the number of characteristic information items which are substantially equal as the two records 162, 164 are compared. The comparison may be effected item-by-item, within the two records 162, 164, for example, or entire records may be compared against other records, on a record-by-record basis. In each case the method of comparison is described as “comparing the characteristic information included in the first selected record with the characteristic information included in the second selected record.”

Thus, for example, the degree of affinity between the users A, B might be characterized as 100%, as each of the pieces of characteristic information matches up within the category selected by the users A, B. However, while there is substantial equivalence (i.e., romantic movies is a sub-category of movies, and “cats” is a sub-category of animals), there is not an identity of information, except with regard to the category of music preferred by the parties, and the sex preferred by the parties. Thus, another way of characterizing the degree of affinity might be finding an identity of information among two categories out of five, or a 40% degree of affinity. The degree of affinity may also be increased, or decreased, depending on the user proximity distance 160. Thus, the degree of affinity will typically increase according to a reduction in the user proximity distance 160. For example, the degree of affinity may be increased by five percentage points based on a user proximity distance of about 5 kilometers, or less. A user proximity distance of less than 1 kilometer, however, might increase the degree of affinity by twenty percentage points.

In any case, once the degree of affinity is determined, a contact module 16 may be used to establish a user call connection 150 between the parties A, B when the degree of affinity is about greater than or equal to a preselected amount of affinity. In the active system 100, the service provider may select the preselected amount or degree of affinity which will be used to enable a call connection between the first and second party users A, B. Moreover, the preselected degree of affinity may change depending on the number of desired call connections operating at any given time, the amount of revenue desired by the service provider, or other considerations. Further, the first and second party users A, B may also elect to require a greater or lesser degree of affinity as the preselected amount of affinity necessary to enable a call connection between users. The preselected amount of affinity may be entered by the users A, B into the database 10 using the data connections 130, 140, respectively. Alternatively, the service provider maintaining the database 10 can solicit the preselected amount of affinity from the users A, B.

The call is established between the parties A and B automatically by the contact module 16. The call connection is established by having the contact module 16 call or page each party. The contact module 16 places the first answering party on hold. An announcement machine (not shown) tells the first answering party to hold until the second answering party answers the phone. When the second party user answers the phone, the second party user receives an indication of an affinity call announcement. Then the call is then established between the first party user and the second party user. If one of the parties is determined to be unavailable, the contact module 16 releases the first answering party after delivering an announcement to the first answering party that the second answering party is unavailable.

Those skilled in the art will realize that the preselected amount of affinity determines the frequency of call connections established within the operation of the invention, and therefore, the amount of revenue which may be generated for any particular service provider. It is foreseeable that contests or “specials” may be offered by the service provider in which reduced rates are made available to those users opting to settle for a lesser degree of preselected affinity to enable a call connection to occur.

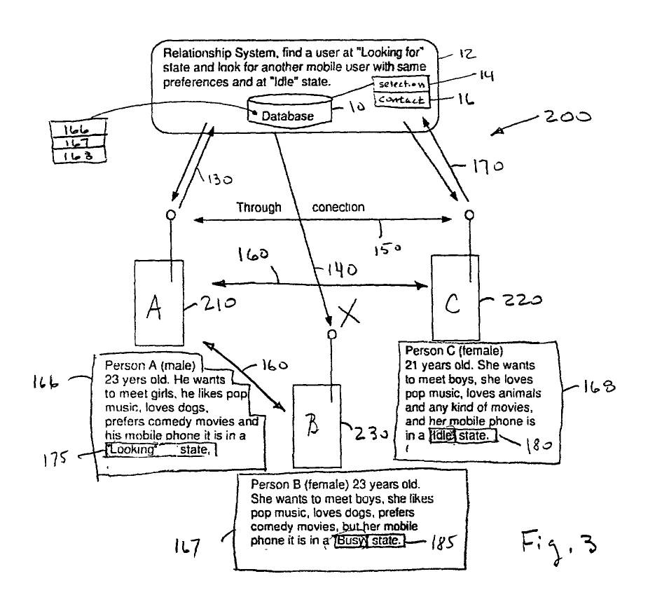

Turning now to FIG. 3, the passive system 200 for determining affinity relationships and enabling communications between users can be seen. In this figure, many of the system elements are similar to, or identical to those illustrated in FIG. 2. The principal difference between the two systems is the use of a “user status” assigned to party users within the system operation. For example, first party user A is associated with record 166, containing characteristic information associated with the user A defining him as male, twenty-three years old, and desirous of meeting girls. He likes pop music, dogs, comedy movies, and in addition to the characteristic information previously described, has designated his telephone 210 to be in a “looking” 175 state, which means that user A has a “looking” 175 status. As a matter of contrast, record 167 indicates that user B is female, twenty-three years old, and wants to meet boys. She likes pop music, dogs, comedy movies, and her status is “busy” 185. Finally, record 168 indicates that user C is female, twenty-one years old, and wants to meet boys. She likes pop music, animals, and any kind of movies. Her phone has been set to an “idle” 180 state, which means that her status is “idle” 180.

In this passive system 200, the degree of affinity will be determined only between parties having some type of “included” status, such as a “looking” 175 status, or an “idle” 180 status. A “looking” status means that the user is actively looking to establish communication with another user. It also means that the user, in this case, user A, is willing to pay for the entire cost of a cellular telephone user call connection 150. That is user A will absorb whatever costs are necessary to pay for his own telephone usage, as well as that incurred by user B or user C. User B, however, has a status of “busy” 185. The “busy” 185 status means that user B currently does not wish to be an active part of the relationship affinity search, and therefore, no degree of affinity with user A will result in enabling a call connection between users A and B. Thus, even though the characteristic information in the records 166, 167 is identical, no call connection 150 will be made between users A and B. User C, on the other hand, has an “idle” 180 status. The “idle” 180 status means that user C is available for call connections 150 based on a preselected amount of affinity, and finding someone, such as user A, who is willing to pay for the telephone call. That is, the user having an “idle” 180 status is available for engaging in conversation with other parties, but does not wish to pay for the cost of a cellular telephone connection. Those skilled in the art will realize that there may be other “included” status preferences, such as a “pay for” field in the records 166-168, which will designate some percentage of a telephone call which users can elect to pay. Thus, users may elect to pay for some portion of the call, default to splitting the cost of the call (the most likely scenario for FIG. 2), or pay for no portion of a call connection 150. As noted in FIG. 2, the telephone 220 associated with user C may communicate with the database 10 using user data connection 170. Similarly, the telephone 230 associated with user B can make use of the user data connection 140, and the telephone 210 associated with user A can make use of the data connection 130, as described above.

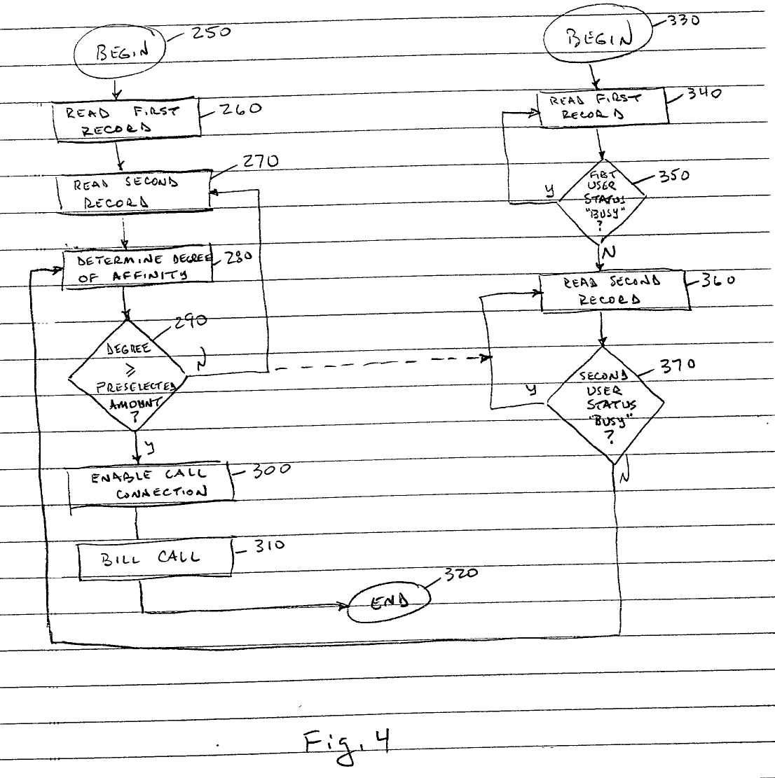

Turning now to FIG. 4, the method of the present invention, as illustrated in flow chart form, can be seen. The method for determining affinity relationships and enabling communication between a first party user and a second party user can begin at steps 250 (for the active system implementation) or step 330 (for the passive system implementation). Assuming that an active system is operating, the method proceeds with step 260 to read a first selected record including characteristic information corresponding to a first party user. The next step 270 involves reading a second selected record, including characteristic information corresponding to a second party user. Steps 260, 270, each designated as “reading a selected record” may be interpreted to mean reading an entire record for comparison with another record, or reading component parts of the record (i.e., individual pieces of characteristic information) for comparison within the records. After the records are read, the degree of affinity is determined by comparing the characteristic information included in the first selected record with the characteristic information included in the second selected record in step 280. The degree of affinity will be compared with a preselected amount of affinity, typically determined by the service provider, and/or the users, to see if the degree of affinity is about greater than or equal to the preselected amount of affinity in step 290. If so, then the call connection is established in Step 300. If not, then other records are read from the database to make comparisons between characteristic information in the first record, and the other records subsequently read. The system will continue scanning records until all of the records are exhausted, or until two records have a degree of affinity which is about greater than or equal to the preselected amount of affinity desired. Once the call connection is established in step 300, and the call is completed, the call will be billed in step 310. The method then terminates in step 320. As noted above, there are many options for billing the call, including splitting the cost between the party users, allocating all the costs to a single user, or apportioning the cost of the call according to percentages desired by the users. Aggressive system operators may elect to notify users of situations where the percentage of payment selected by the parties is approaching 100%, but has not quite reached the full amount of a call. This option will allow one or the other of the users to pay for the balance of the call which has not yet been designated as part of their respective, selected percentages. Alternatively, if the percentages do not add up to 100% between two users having the required degree of affinity, the system may elect to continue scanning records until the proper conditions are met.

As noted above, the passive system method may begin at step 330, and continue with reading the first record at step 340. If the first user status, associated with the first record, is “busy”, then another record will be read to take the place of the first record in step 340, as determined in step 350. However, if the first user status is not “busy”, then the method continues with step 360, wherein the second record is read. Again, the status of the second user is checked to determine if it is “busy” in step 370. If so, then another record is read to take the place of the second record in step 360, until a record is found wherein the user status is not busy (i.e., the user has selected some type of “included” status). Once two records have been found wherein the user status is not “busy”, the method can continue with step 280, wherein the degree of affinity is determined. If the required degree of affinity is not found, record scanning continues with step 360. The status of the users, e.g., “looking”, “pay for”, or “idle” can also be used to determine the manner of billing the call in step 310, as described above. This invention can be combined with other services, such as three-way calling and conference calling, to provide relationships and affinity stacking between groups.

Although the invention has been described with reference to specific embodiments, this description is not meant to be construed in a limited sense. The various modifications of the disclosed embodiments, as well as alternative embodiments of the invention, will become apparent to persons skilled in the art upon reference to the description of the invention. It is, therefore, contemplated that the appended claims will cover such modifications that fall within the scope of the invention, or their equivalents.

What is claimed is:

1. An active system for determining affinity relationships and enabling communication between a first party user and a second party user, comprising:
a memory having a database including a plurality of records, wherein a first selected record of the plurality of records includes characteristic information corresponding to the first party user, and wherein a second selected record of the plurality of records includes characteristic information corresponding to the second party user;
a selection module for comparing the characteristic information included in the first selected record with the characteristic information included in the second selected record to determine a degree of affinity; and
a contact module for establishing a call connection between the first party user and the second party user when the degree of affinity is about greater than or equal to a preselected amount of affinity.

2. The active system of claim 1, wherein the memory is included in a telecommunications node.

3. The active system of claim 1, wherein the plurality of records is divided into at least two series of records.

4. The active system of claim 1, wherein the degree of affinity increases according to an amount of the characteristic information included in the first selected record which is substantially equivalent to the characteristic information included in the second selected record.

5. The active system of claim 1, wherein the first party user and the second party user are separated by a user proximity distance, and wherein the degree of affinity increases according to a reduction in the user proximity distance.

6. A passive system for determining affinity relationships and enabling communication between a first party user having a first user status and a second party user having a second user status, comprising:
a memory having a database including a plurality of records, wherein a first selected record of the plurality of records includes characteristic information corresponding to the first party user, and wherein a second selected record of the plurality of records includes characteristic information corresponding to the second party user;
a selection module for comparing the characteristic information included in the first selected record with the characteristic information included in the second selected record to determine a degree of affinity; and
a contact module for establishing a call connection between the first party user and the second party user when the degree of affinity is about greater than or equal to a preselected amount of affinity and when the first user status is “included” and the second user status is “included”.

7. The passive system of claim 6, wherein the memory is included in a telecommunications node.

8. The passive system of claim 6, wherein the plurality of records is divided into at least two series of records.

9. The passive system of claim 6, wherein the degree of affinity increases according to an amount of the characteristic information included in the first selected record which is substantially equivalent to the characteristic information included in the second selected record.

10. The passive system of claim 6, wherein the first party user and the second party user are separated by a user proximity distance, and wherein the degree of affinity increases according to a reduction in the user proximity distance.

11. The passive system of claim 6, wherein the “included” status of the first user is “looking”.

12. The passive system of claim 11, wherein the “included” status of the second user is “looking”.

13. The passive system of claim 11, wherein the “included” status of the second user is “idle”.

14. A method for determining affinity relationships and enabling communication between a first party user and a second party user, comprising the steps of:
reading a first selected record including characteristic information corresponding to the first party user;
reading a second selected record including characteristic information corresponding to the second party user;
determining a degree of affinity by comparing the characteristic information included in the first selected record with the characteristic information included in the second selected record; and
establishing a call connection between the first party user and the second party user when the degree of affinity is about greater than or equal to a preselected amount of affinity.

15. The method of claim 14, wherein the degree of affinity increases according to an amount of the characteristic information included in the first selected record which is substantially equivalent to the characteristic information included in the second selected record.

16. The method of claim 14, wherein the first party user and the second party user are separated by a user proximity distance, and wherein the degree of affinity increases according to a reduction in the user proximity distance.

17. The method of claim 14, wherein the characteristic information included in the first selected record includes an age of the first party user.

18. The method of claim 14, wherein the characteristic information included in the first selected record includes a sex of the first party user.

19. The method of claim 14, wherein the characteristic information included in the first selected record includes a music type preferred by the first party user.

20. The method of claim 14, wherein the characteristic information included in the first selected record includes a telephone number of the first party user.

21. The method of claim 14, wherein the first party user is associated with a first user status and the second party user is associated with a second user status, and wherein the step of enabling a call connection between the first party user and the second party user when the degree of affinity is about greater than or equal to a preselected amount of affinity includes the step of enabling a call connection only when the first user status is “looking” and the second user status is “looking” or “idle.”

22. The method of claim 14, wherein the step of establishing a call connection between the first party user and the second party user includes the steps of:
determining that the first party user is available;
determining that the second party user is available; and
completing the call between the first party user and the second party user.

23. The method of claim 22, wherein the step of determining that the first party user is available further includes the steps of:
paging the first party user;
placing the first party user on hold; and
indicating to the first party user that the second party user is being contacted.

24. The method of claim 22, wherein the step of determining that the second party user is available further includes the steps of:
paging the second party user; and
indicating to the second party user that they have an affinity call from the first party user.
